(19) United States
(12) Patent Application Publication
(10) Pub. No.: US 2005/0178470 A1
(43) Pub. Date: Aug. 18, 2005

(54) Dust protection seat for the blade shaft of a wood-planing device

(76) Inventor: Chun Hsiang Wang, Taichung Hsien (TW)

Correspondence Address: Leong C. LEI, PMB #1008, 1867 Ygnacio Valley Road, Walnut Creek, CA, 94598, US

(21) Appl. No.: 10/777,110

(22) Filed: Feb. 13, 2004

(51) Int. Cl. B27C 1/00; B23C 1/00; B27G 19/00; B27G 21/00

(52) U.S. Cl. 144/252.1; 144/114.1; 409/137

(57) ABSTRACT

A dust protection seat for the blade shaft of a wood-planing device is disclosed. The dust prevention seat for the blade shaft of a wood planning device has a small volume that facilitates storage and transporting and the method of fabrication is simple and the cost of production is low. In addition, if partial of the device component is damaged, the component can be replaced.

### BACKGROUND OF THE INVENTION

(a) Technical Field of the Invention

The present invention relates to a dust protection seat, and in particular, a dust protection seat for the blade shaft of a wood-planing device. The seat has a small volume that facilitates storage and transporting and the method of fabrication is simple and the cost of production is low. In addition, if partial of the device component is damaged, the component can be replaced.

(b) Description of the Prior Art

As shown in FIGS. 1, 2 and 3, there is shown a conventional dust-proof seat 2 for the blade shaft of a wood-planing device having a working platform 15 on the device body of the wood-planing device. A semi-circular shape protection cover 20 for the blade shaft 16 is provided on the working platform 15. The two sides of the top surface of the protection cover 20 are provided with an elongated slot 200 allowing a fastening latch 29 to lock to the working platform 15, and protection cover 20 can be adjusted to correspond to the front and rear position, as shown in FIG. 3 of the blade shaft 16. One side of the protection cover 20 is protruded with a securing plate 21, wherein a T-shaped latching rod 22 and an adjusting knob 220 are used to lock an urging plate 23 having a corresponding T-shape slot 230 to urge a working piece. The combination of the T-shaped latching rod 22 and the T-shaped slot 230 adjusts the left and right position of the urging plate 23, as shown in FIG. 2. The protective cover 20 is positioned at a different position of the horizontal securing plate 21 to form a leaning face 24 having a locking hole 240. The leaning face 24 has a cornered adjusting plate 26 having a corresponding adjusting hole 260. The end face of the adjusting plate 26 is provided with a screw hole 261 and the protective cover 20 is a protruded lug 25 having a pivotal hole 250 for using the adjusting latch 27 provided on the protruded lug 25 to adjust the position of the cornered adjusting plate 26, as. shown in FIG. 4. The adjusting latch 28 can be locked or to loose adjusting plate 26. At the same time, the adjusting plate 26 makes use of the urging plate 23 to move the position of the plate 23, as shown in FIG. 2, and to adjust the size of opening of planing. The adjusting plate 26 can be used to adjust the front and rear position of the leaning plate 23.

As shown in FIG. 5, the adjusting seat 40 is an inverted L-shaped securing frame 41 locked to the working platform 15. The free end of the securing frame 41 is provided with a cover block 42 having a packing latch 420. The cover block 42 is provided with an extension rod 43 having a securing slot 430. The front and rear section of the extension rod 43 are an adjusting block 44, 47 having a packing latch 440, 470. The two adjusting blocks 44, 47 are respectively mounted with upright rods 45, 48 and the packing latch 450, 480 are used to adjust the height and the bottom end of the two upright rods 45, 48 are respectively mounted with a press block 46 and a blocking plate 49 to stop a working piece or to block dust.

The drawbacks of the conventional protection cover are that the cost of production is high and zinc material is used and if a small part is defect in the fabrication process, the entire piece has to be discarded. The other drawbacks are that-the capacity is large and is not convenient in shipping, and the entire structure has to be discarded in case a small component is defect. Another drawback of the conventional seat is that the longevity is short due to the fact that zinc material will undergo oxidation. Accordingly, it is an object of the present invention to provide a dust protection seat for the blade shaft of a wood-planing device which mitigates the above drawbacks.

### SUMMARY OF THE INVENTION

Accordingly, it is an object of the present invention to provide a dust prevention seat for the blade shaft of a wood planning device having a protection cover module and an adjusting seat, the protection cover module positioned at a working platform of the device body of the planning device and covering the blade shaft protruded from the working platform and the adjusting seat positioned on the protection cover module to urge a work piece and block dust, characterized in that the protection cover module includes a rear plate, two side plates, two moving cornered plate and a cover plate seat, the two sides of the rear plate are extended forwardly on engaging plate for engagement with the side plate, and the two side plates are formed with corresponding engaging slots for locking with a lock component, and the top edge of the two side plates are formed with a long slot for adjustment of front and rear position, and the surface of the cornered plate corresponding to the two side plates is formed with a long adjusting hole and the adjusting hole is locked to a latching rod at the side plate, and the horizontal section of the cornered plate is slidably mounted with a leaning plate; and the cover plate seat locked to the rear plate and the side plate is a plate body, and the two sides of the cover plate seat are formed with long slots corresponding to the long slot of the side plate, and screw latch is used to lock the cover plate seat and the side plate of the protection cover module to the working platform

Still another object of the invention is to provide a dust protection seat for the blade shaft of a wood-planing device, wherein the rear plate of the protection cover module has a through hole mounted with a tube seat connected to a wind tube, an engaging structure is used to engage to the through hole so that the wind tube sucks away saw dust during a planning process.

Yet another object of the present invention is to provide a dust protection seat for the blade shaft of a wood-planing device, wherein the two sides of the rear plate of the protection cover module are protrudingly mounted with protruded plate pivotally mounted with an adjusting latch and the end face of the moving cornered plate corresponding to the protruded plate is a screw hole for the mounting of the adjusting latch, and the rotating of the adjusting latch adjust the front and rear position of the cornered plate.

Yet still another object of the present invention is to provide a dust protection seat for the blade shaft of a wood-planing device, wherein a T-shaped latching rod and an adjusting knob are used to lock the leaning plate and the rear face of the leaning plate is provided with T-shaped sliding slot.

The foregoing object and summary provide only a brief introduction to the present invention. To filly appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of a conventional dust protection seat for the blade shaft of a wood-planing tool.

FIG. 2 is a schematic view showing the urging plate action of the conventional dust protection seat.

FIG. 3 is a schematic view of the protection cover action of the conventional dust protection seat.

FIG. 4 is a schematic view showing the comer-shape adjusting action of the conventional dust protection seat.

FIG. 5 is a schematic view showing the adjusting seat action of the conventional dust protection seat.

FIG. 6 is an exploded perspective view of the dust protection seat of the blade shaft of a wood-planing device of the present invention.

FIG. 7 is a perspective view of the dust protection seat for the blade shaft of the wood-planing tool of the present invention.

FIG. 8 is a schematic view of the dust protection seat of the present invention.

FIG. 9 is a perspective exploded view of the adjusting seat of the present invention.

FIGS. 10, 10A, 10B are schematic views showing the adjusting action of the adjusting seat of the present invention.

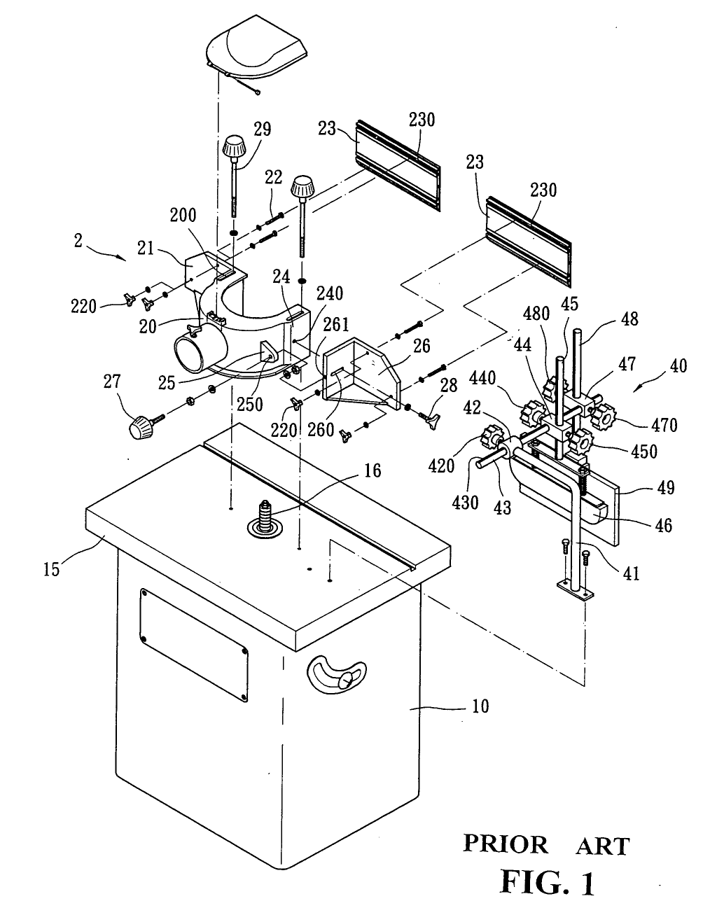

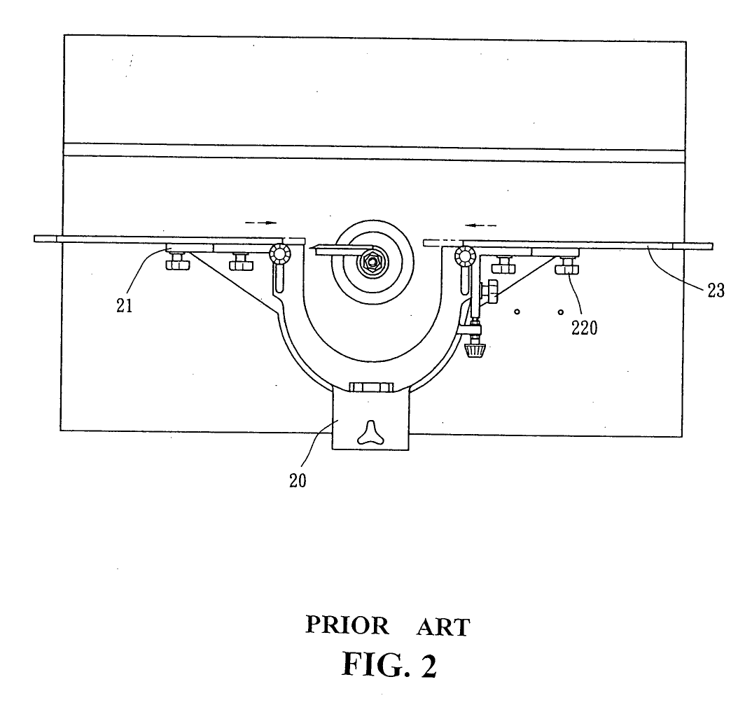

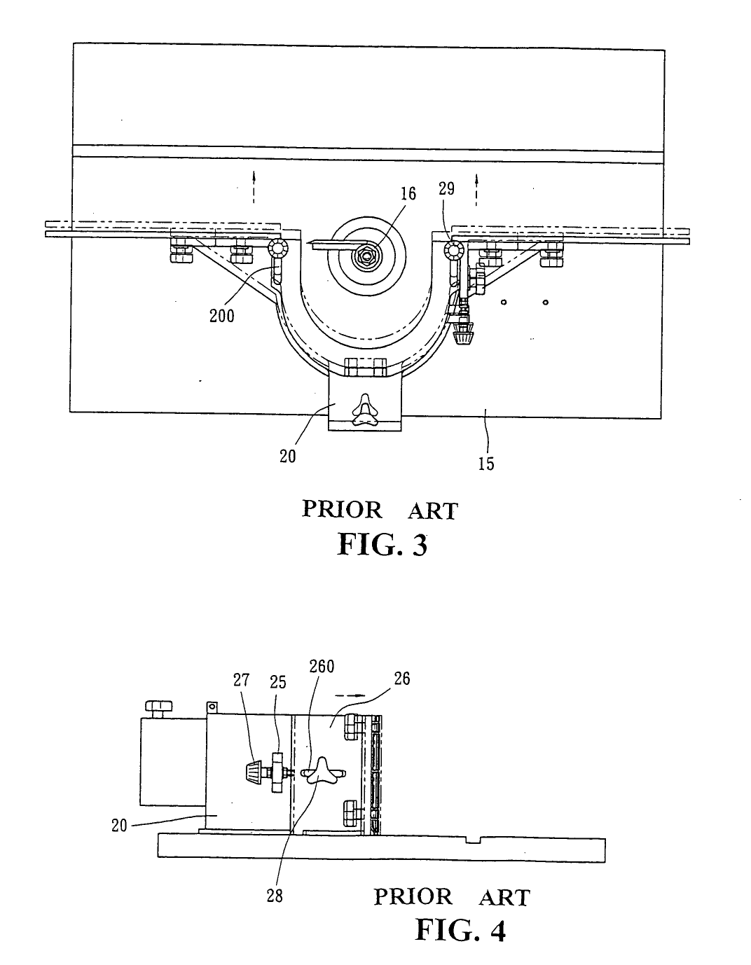

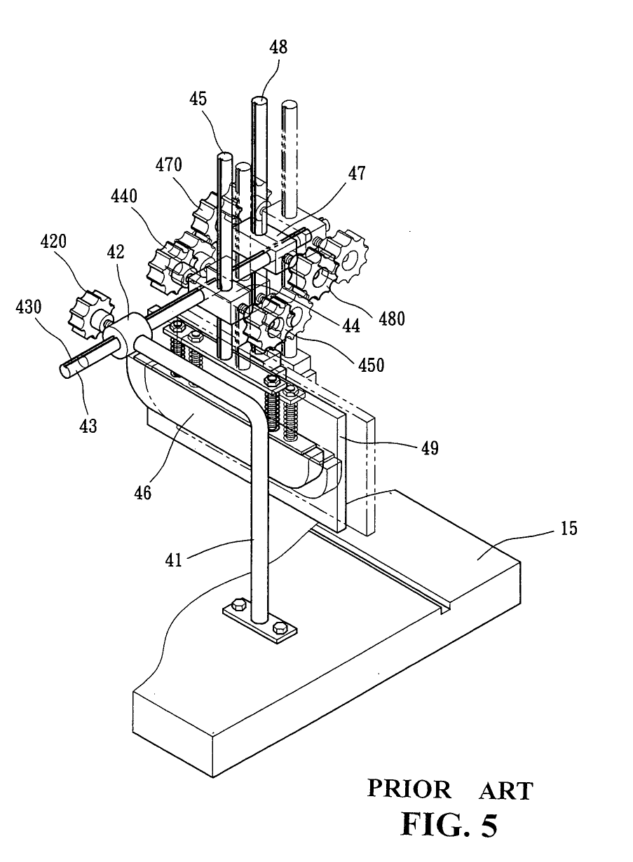

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

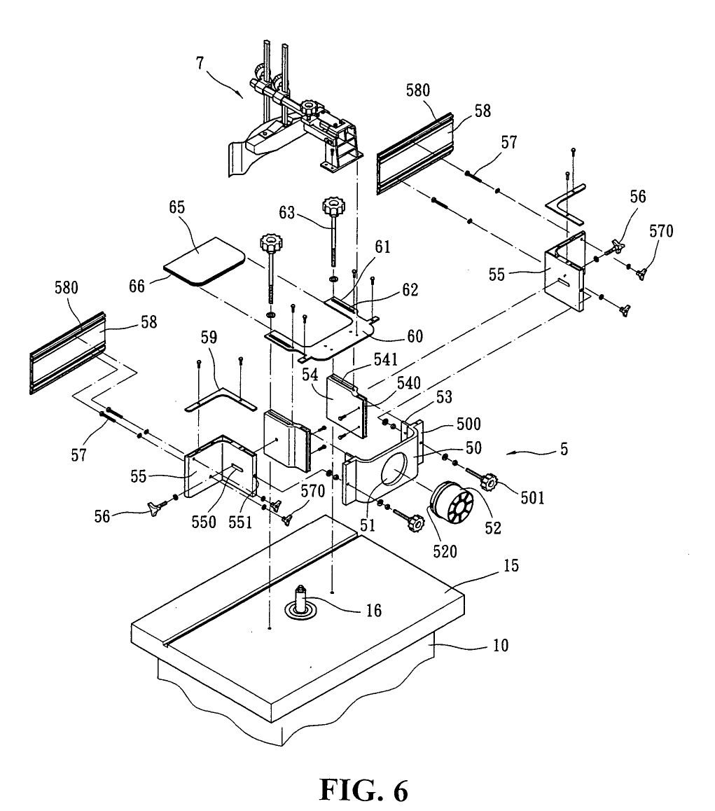

Referring to FIG. 6, there is shown a dust protection seat 5 for the blade shaft of a wood-planing device comprising a protective cover module and an adjusting seat 7. The protective cover module is mounted on the working platform 15 of the device body 10 of the wood-planing device and covers the blade shaft 16 protruded out from the working platform 15, allowing a work piece to lean against and allowing the scope of adjustment of the planing blade. The adjusting seat 7 is mounted on the protective cover module to urge a work piece and to block dust.

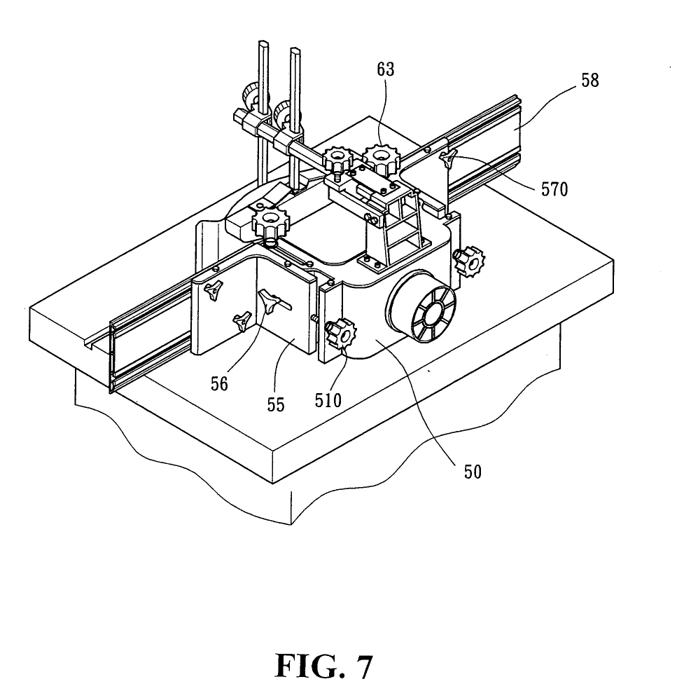

As shown in FIGS. 6 and 7, the protective module includes a rear plate 50, two side plates 54, two moving cornered plate 55 and a covering seat 60 which are made by extruding of aluminium material.

The two lateral sides of the rear plate 50 are protruded out with horizontal protruded plate 500 and the two protruded plates 500 are pivotally mounted with an adjusting latch 501. Further, the rear plate 50 is formed with a through hole 51, and the through hole 51 is a tube seat 52 connected to a wind tube. The tube seat 52 has an engaging structure 520 to engage with the through hole 51 of the rear plate 50 to allow the wind tube to suck away the saw dust after a wood-planing process. The two lateral sides of the rear plate 50 are extended forward with an engaging plate 53 for engaging with a side plate 54. The two side plates 54 are formed with corresponding engaging slot 540 which is urged or locked by means of a locking component. The top edge of the two side plates 54 is formed into a through elongated slot 541 for adjusting the front and rear position of the protective cover module. The surface at the outer side of the two side plates 54 corresponding to the moving cornered plate 55 is formed into a long adjusting hole 550. The two moving cornered plates 55 employ a latching rod 56 to pass through the adjusting hole 550 and locked to the outer side face of the two side plates 54. The end face of the protruded plate 500 corresponding to the moving cornered plate 55 is formed a screw hole 551 and the screw hole 551 allows the adjusting latch 501 of the protruded plate 500 to be locked and the rotating of the adjusting latch 501 adjusts the front and rear position of the moving cornered plate 55, and the long adjusting hole 550 is used to adjust the front and rear position of the moving cornered plate 55. Another horizontal section of the two moving cornered plate 55 employs a T-shaped latching rod 57 and an adjusting knob 570 to respectively locked to a leaning plate 58 having a T-shaped sliding slot 580 to lean against a work piece. The top face of the two moving cornered plate 55 is provided with a corresponding shape cornered cover plate 59 to prevent the accumulation of debris as a result of the through hole of the cornered plate 55.

The cover plate seat 60 locked to the rear plate 50 and the side plate 54 is recessed plate body, and the two sides of the cover plate seat 60 is extended forward with a lateral plate corresponding to the side plate 54. The two side plates 61 are formed into long slot 62 corresponding to the long slot 541 of the side plate 54 so that the screw latch 63 is used to lock the side plate 54 of the protective cover module and the cover plate 60 onto the working platform 15. Between the two side plates 61 of the cover plate seat 60, a cover plate 65 having a corresponding shape is engaged. The circumferential edge of the cover plate 65 has an engaging slot 66 so that the cover plate 65 can slidably engage to the cover plate seat 60, facilitating loading and unloading.

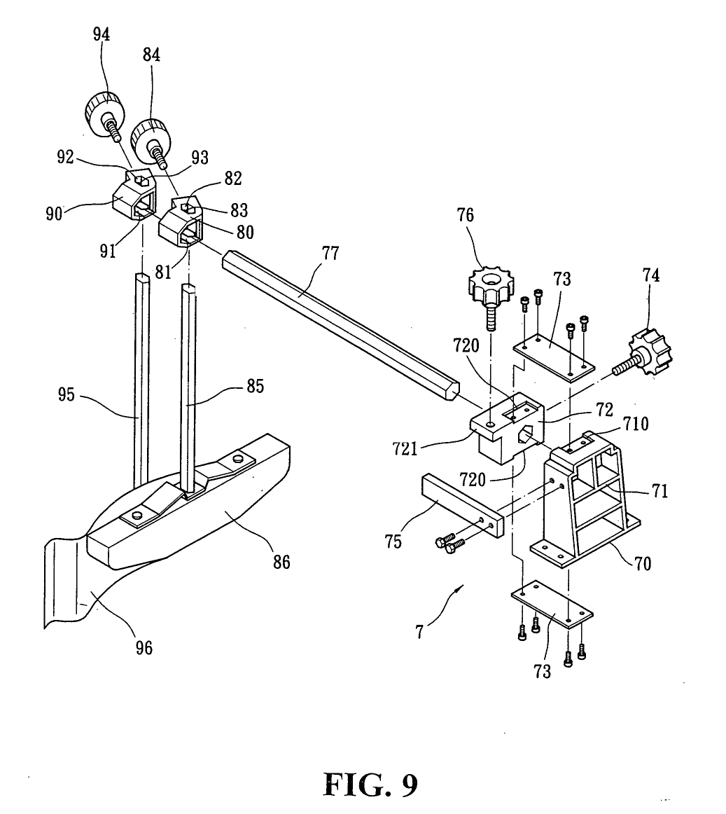

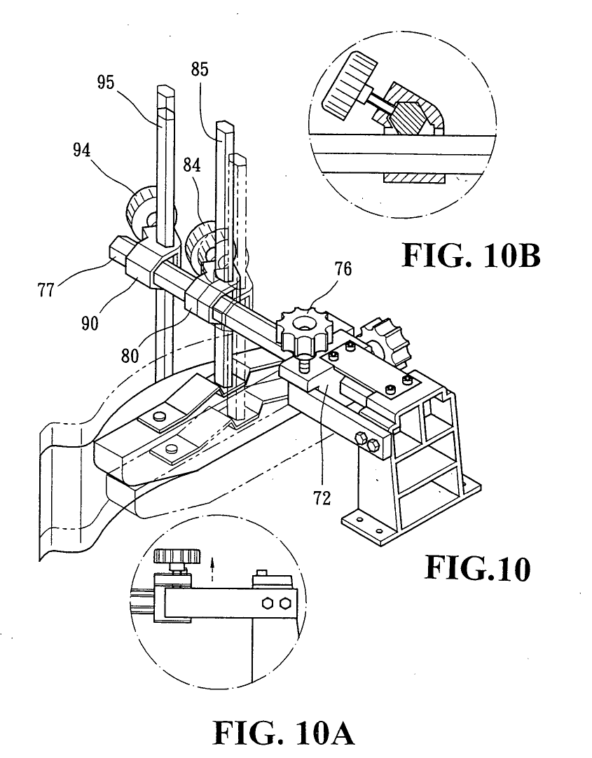

FIGS. 9, 10, 10A and 10B show the structure of the adjusting seat 7. The securing frame 70 is mounted onto the top face of the cover plate seat 60 and the middle section of the securing frame 70 is a partition plate 71. The securing frame 70 at the top face and the bottom face of the partition plate 71 are formed with corresponding engaging slot 710. The front section of the securing frame 70 is provided with a seat block 72, and the top and bottom end face of the seat block 72 are formed with an engaging slot 720 corresponding to the engaging slot 710 of the securing frame 70. The securing frame 70 and the seat block 72 are mounted together with a locking plate 73. Thus, the center of the seat block 72 is mounted with a polygonal rod 77 and one side of the seat block 72 is locked with a screw latch 74. The seat block 72 is at different side of the top edge of the screw latch 74 and is extended with a protruded block 721. At the same lateral side of the securing frame 70 is positioned with a corresponding securing block 75 and the protruded block 721 of the seat block 72 is locked with a screw latch 76 which urges the securing block 75 so as to adjust the height of the polygonal rod 77, partially shown in FIG. 10A, and a pressing structure and a blocking plate structure are mounted to the polygonal rod 77.

The polygonal rod 77 is mounted with a sliding mount 80 having polygonal hole 81 for the mounting of the polygonal rod 77. The top face of the sliding mount 80 has a vertical hole 82 having one side in communication with a horizontal hole 81 at one side, as shown in FIG. 10B. The sliding mount 80 has an inclined locking hole 83 in communication with the vertical hole 82. The inclined locking hole 83 is provided with a screw latch 84 and the vertical hole 82 is for the insertion of an vertical rod 85 having a press block 86 at the bottom end. Thus, when the screw latch 84 is tighten to the vertical rod 85, the vertical rod 85 will press against the polygonal rod 77. Thus, a single tightening of the screw latch 84 will loosen or tighten the vertical rod 85 and the polygonal rod 77. Therefore the height and the front and rear position of the pressing structure can be easily and conveniently adjusted.

The pressing structure of the polygonal rod 77 is mounted with a sliding mount 90 at the front thereof The sliding mount 90 is provided with horizontal hole 91 for the passage of the rod 77. The top face of the sliding mount 90 is formed with vertical hole 92 and one side edge of the vertical hole 92 and the horizontal hole 91 are in communication at one side, partially shown in FIG. 10B. The sliding mount 90 is formed with an inclined locking hole 93 in communication with the vertical hole 92. The inclined locking hole 93 has a screw latch 94, and the vertical hole 92 provides passage for a vertical rod 95 having a blocking plate 96 at the bottom end. Thus, when the screw latch 94 is tighten to the vertical rod 95, the vertical rod 95 at the same time presses against the rod 77. Thus, a single tightening of the screw latch 94 will loosen or tighten the vertical rod or the polygonal rod 77, thus the height and the front and rear position of the blocking plate structure can be easily and conveniently adjusted.

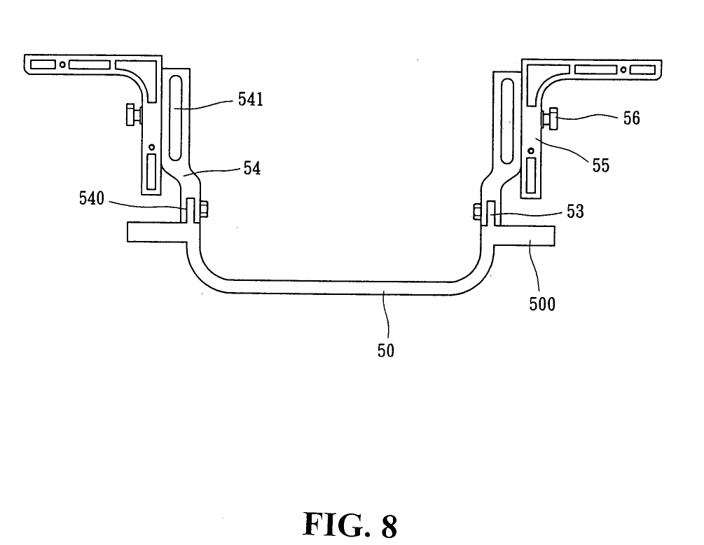

As for application of the present invention, as shown in FIGS. 7, and 8, the latching rod 56 of the moving cornered plate 55 is loosen, and the adjusting latch 501 at the rear plate 50 is rotated. Thus, the front and rear position of the moving cornered plate 55 is adjusted so as to determine the depth of the planing process. In combination with the adjustment of the work piece, the adjusting knob 570 of the T-shaped latching rod 57 can be loosen so that the left and right position of the leaning plate 58 is adjusted so as to determine the range of planing. At the same time, the screw latch 63 to the side plate 54 can be adjusted to adjust the front and rear position of the entire protective cover module.

When the position of the pressing structure and the blocking plate structure on the adjusting seat 7 are to be adjusted, as shown in FIG. 10, the screw latch 76 of the seat block 72 is used to fine tune the height of the polygonal rod 77. Also, the screw latch 84, 94 on the sliding mount 80, 90 can be loosen and this will adjust the front and rear position of the sliding mount 80, 90 with respect to the polygonal rod 77, and at the same time, the vertical rod 85, 95 with respect to the height of the mount 80, 90 is adjusted to comply with the requirement of planing process.

The advantages of the present invention are that (i) cost of production is low, (ii) the volume of the device is small which facilitates storage and shipping, (iii) the components of the device can be partially changed, (iv) the longevity of the device is extended, and (v) the device is easily operated.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A dust prevention seat for the blade shaft of a wood-planing device having a protection cover module and an adjusting seat, the protection cover module positioned at a working platform of the device body of the planing device and covering the blade shaft protruded from the working platform and the adjusting seat positioned on the protection cover module to urge a work piece and block dust, characterized in that:
the protection cover module includes a rear plate, two side plates, two moving cornered plate and a cover plate seat, the two sides of the rear plate are extended forwardly on engaging plate for engagement with the side plate, and the two side plates are formed with corresponding engaging slots for locking with a lock component, and the top edge of the two side plates are formed with a long slot for adjustment of front and rear position, and the surface of the cornered plate corresponding to the two side plates is formed with a long adjusting hole and the adjusting hole is locked to a latching rod at the side plate, and the horizontal section of the cornered plate is slidably mounted with a leaning plate; and the cover plate seat locked to the rear plate and the side plate is a plate body, and the two sides of the cover plate seat are formed with long slots corresponding to the long slot of the side plate, and screw latch is used to lock the cover plate seat and the side plate of the protection cover module to the working platform.

2. The dust protection seat of claim 1, wherein the rear plate of the protection cover module has a through hole mounted with a tube seat connected to a wind tube, an engaging structure is used to engage to the through hole so that the wind tube sucks away saw dust during a planing process.

3. The dust protection seat of claim 1, wherein the two sides of the rear plate of the protection cover module are protrudingly mounted with protruded plate pivotally mounted with an adjusting latch and the end face of the moving cornered plate corresponding to the protruded plate is a screw hole for the mounting of the adjusting latch, and the rotating of the adjusting latch adjust the front and rear position of the cornered plate.

4. The dust protection seat of claim 1, wherein a T-shaped latching rod and an adjusting knob are used to lock the leaning plate and the rear face of the leaning plate is provided with T-shaped sliding slot.

5. The dust protection seat of claim 1, wherein the top face of the cornered plate is provided with a cornered covering plate to avoid accumulation of debris at the through hole.

6. The dust protection seat of claim 1, wherein the cover plate seat is a recessed plate body, and the two sides of the cover plate seat is forwardly extended a corresponding side plate, and a long slot is formed on the two side plates, and between the two side plates; a cover plate is formed and the circumferential edge of the cover plate is provided with an engaging slot to allow the cover plate to slidably engage with the cover plate seat, facilitating loading and unloading.

7. The dust protection seat of claim 1, wherein the adjusting seat is mounted to the top face of the cover plate seat of the protection cover module by a securing frame, and the front position of the securing frame is a seat block, and the securing frame and the seat block are co-mounted to a locking plate, and the center of the seat block is provided with a polygonal rod, and one side of the seat body is a screw latch for tightening the polygonal rod, and the polygonal rod includes a pressing structure and a blocking plate structure.

8. The dust protection seat of claim 7, wherein the middle section of the securing seat is a partition plate and the securing frame is formed with an engaging slot at the top face and the bottom face of the partition plate, and the top and bottom end face of the seat block are respectively formed with engaging slot corresponding to the engaging slot of the securing frame, and the engaging slot is used to engage with the locking plate for locking.

9. The dust protection seat of claim 7, wherein the seat block is provided with a protruded block extended from the top edge of seat block and one side of the securing frame is positioned with a corresponding securing block and a protruded block from the seat block is locked with a screw latch which can urge the securing block so as to fine adjusting the height of the polygonal rod.

10. The dust protection seat of claim 7, wherein the pressing structure and the blocking plate structure are mounted with a sliding mount on the polygonal rod and the sliding mount is provided with polygonal horizontal hole for the passage of the polygonal rod, and the top face of the sliding mount is formed with a polygonal vertical hole, and one side of the vertical hole is in communication with a horizontal hole at one side, and the sliding mount is formed with an inclined locking hole in communication with the vertical hole, the inclined locking hole is provided with a screw latch and the vertical hole allows the passage of a vertical rod having a press block or blocking plate at the bottom end thereof.
